(19) United States
(12) Patent Application Publication
(10) Pub. No.: US 2014/0330957 A1
(43) Pub. Date: Nov. 6, 2014

(54) WIDI CLOUD MODE

(71) Applicant: INTEL CORPORATION, Santa Clara, CA (US)

(72) Inventors: Zhiwei Ying, Shanghai (CN); Changliang Wang, Bellevue, WA (US); Penne Lee, Bellevue, WA (US); Radhakrishnan Venkataraman, Folsom, CA (US)

(21) Appl. No.: 13/976,818

(22) PCT Filed: Aug. 21, 2012
(86) PCT No.: PCT/CN2012/080407

§ 371 Date: Jul. 14, 2014

(51) Int. Cl. H04L 29/06; H04L 12/26

(52) U.S. Cl. CPC H04L 65/60; H04L 43/0811; H04L 63/0428
USPC 709/224

(57) ABSTRACT

A method and system is provided for WiDi cloud mode. The method includes sending a command from a computing device to a cloud network. A connection between the cloud network and a remote adapter based on the command may be monitored. A data stream sent from the cloud network to the remote adapter via the connection may be controlled.

### TECHNICAL FIELD

The present invention relates generally to wireless display (WiDi). More specifically, the present invention relates to WiDi using a cloud mode.

### BACKGROUND ART

Wireless display (WiDi) is a technique by which a desktop of a computing device is rendered on a remote display, wirelessly. For example, a tablet device may send all images on its desktop to a television to be rendered. Typical uses for WiDi may include online video playback over a web browser and video chat. Each of these uses involves a power intensive process flow that can consume a relatively large portion of the computing device's power. The use of WiDi becomes even more power intensive when the video playback originates from a network source, as is the case when downloading the video stream to the device from a network such as the Internet.

### BRIEF DESCRIPTION OF THE DRAWINGS

FIG. 1 is a diagram describing WiDi, in accordance with embodiments;

FIG. 2 is a diagram describing WiDi in desktop mode, in accordance with embodiments;

FIG. 3 is a process flow diagram describing the processing pipeline for performing WiDi in desktop mode;

FIG. 4 is a diagram describing WiDi in extended mode, in accordance with embodiments;

FIG. 5 is a process flow diagram describing the processing pipeline for using WiDi in extended mode;

FIG. 6 is a diagram describing WiDi in cloud mode, in accordance with embodiments, in accordance with embodiments;

FIG. 7 is a block diagram of a computing device that may be used to perform WiDi in cloud mode, in accordance with embodiments;

FIG. 8 is a process flow diagram showing a method for WiDi cloud mode, in accordance with embodiments;

FIG. 9 is a diagram describing WiDi in personal cloud mode, in accordance with embodiments;

FIG. 10 is a diagram describing WiDi cloud mode with a cloud controller, in accordance with embodiments;

FIG. 11 is a block diagram showing tangible, non-transitory computer-readable media that stores code for WiDi cloud mode, in accordance with embodiments;

FIG. 12 is a block diagram of an exemplary system for implementing WiDi cloud mode; and

FIG. 13 is a schematic of a small form factor device in which the system of FIG. 12 may be embodied.

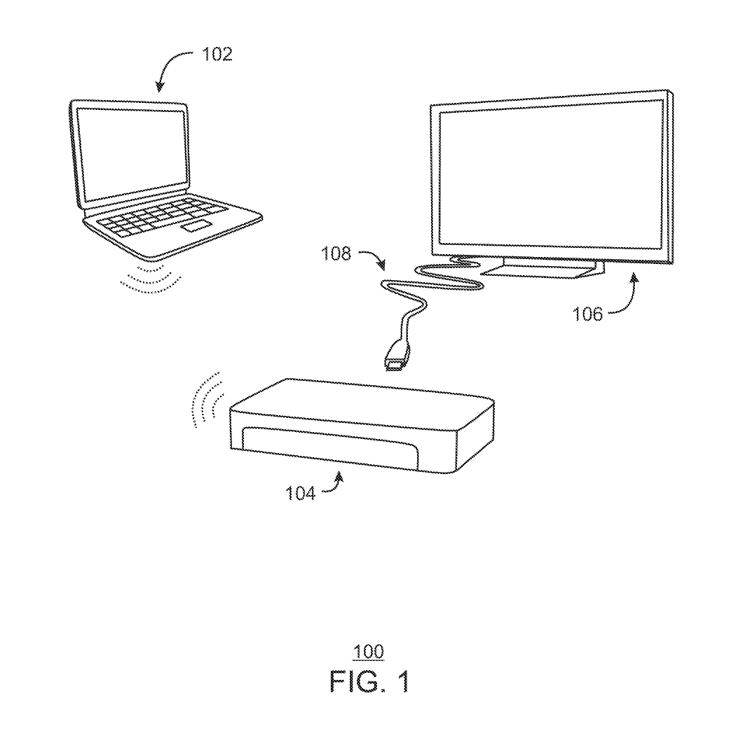

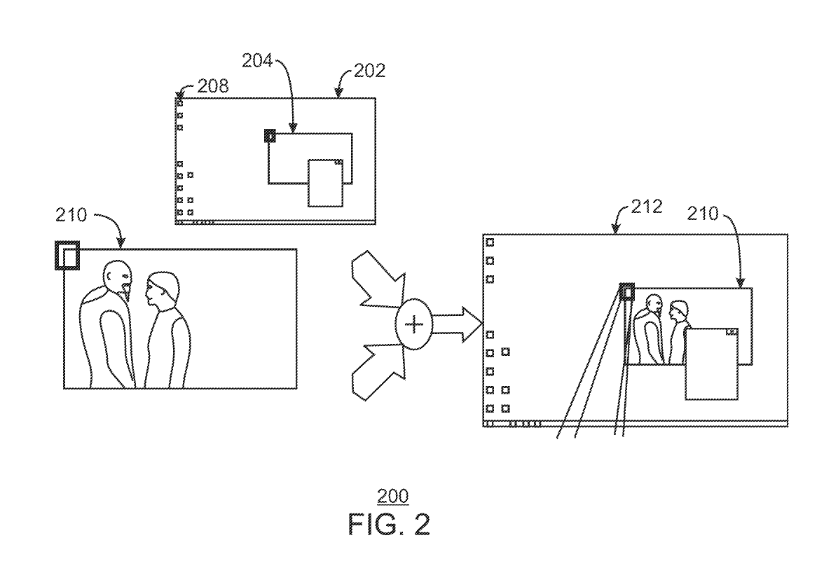

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

As discussed above, WiDi is a technique by which the images on a display of a computing device are wirelessly rendered on a remote display. The display of a computing device may be referred to as a desktop, and can include several icons and applications in various positions on the desktop. Traditional implementations of WiDi encode the entire content of the desktop, wirelessly send the encoded desktop to another device, then decode and process the entire desktop in order to render the desktop on another display, such as a television or computer monitor. In this manner, streaming videos from the Internet may be sent to a mobile computing device then rendered on a television using WiDi. A mobile computing device may refer to any device having a processing system and a mobile power source or supply, such as one or more batteries, for example.

When using battery power, the power available to the mobile computing device may be limited. It can be power intensive to download a video stream, process the stream, and transmit the video stream to a remote adapter in order to render the video stream a remote display using WiDi. Accordingly, embodiments described herein relate to a WiDi cloud mode. During cloud mode, online videos may be rendered on a remote display with negligible power consumption by the computing device.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the inventions. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

FIG. 1 is a diagram 100 describing WiDi, in accordance with embodiments. The diagram 100 includes a computing device as shown by a laptop 102. In the example of FIG. 1, the laptop 102 is a mobile computing device. The laptop 102 may send its display to a remote adapter 104 using wireless capabilities. Accordingly, the remote adapter may be physically separated from the laptop 102. In embodiments, the remote adapter 104 is another computing device. The remote adapter 104 may be connected to a remote device 106 using cable 108. The cable 108 may be any type of cable capable of connecting the remote adapter 104 to the remote device 106. In embodiments, the remote adapter 104 and the remote device 106 are the same component.

FIG. 2 is a diagram 200 describing WiDi in desktop mode, in accordance with embodiments. The diagram 200 includes a desktop 202. The desktop 202 may be, for example, the desktop of the laptop 102 (FIG. 1). The desktop 202 includes a video portion 204. The components of the desktop 202 other than the video portion 204 are typically fixed while the video portion 204 plays video selected by a user. For example, the icon at reference number 206 is generally static while the video portion 204 is dynamic, as is the case when a video is being played within the video portion 204. Thus, a video 210 may be playing within the video portion 204, while the remainder of the desktop is static.

When WiDi is performed in desktop mode, the dynamic portions of the desktop 202 may be composed with the static portions of the desktop 202 and then transmitted to the remote adapter. The remote adapter then processes the incoming signal and sends the processed signal to a remote device to be rendered. Accordingly, a display 212 may be used to render the video 210 on a remote device, such as the remote device 106 (FIG. 1). There may be several processes within the processing pipeline when performing WiDi in desktop mode.

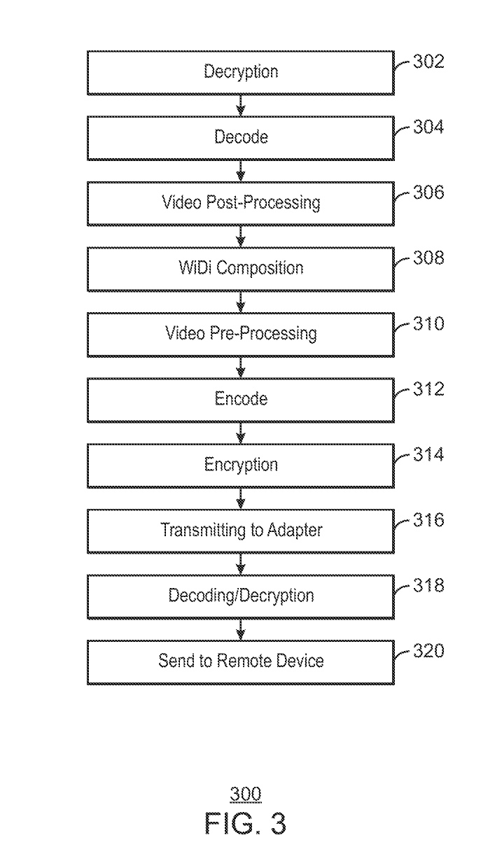

FIG. 3 is a process flow diagram 300 describing the processing pipeline for performing WiDi in desktop mode. As used herein, a pipeline refers to a set of linked computing processes. Data is sent as input to the first process in the pipeline, the output of each process is sent to the next process as input until data has exited the linked set of processes. The various processes of a traditional pipeline for WiDi in desktop mode can consume a large portion of processing time and power when compared to the capabilities of mobile computing devices or any other device with a finite amount of power.

At block 302, an incoming video stream may be decrypted. The decryption may occur when the incoming video stream is in a format that is not in the format desired by the computing device receiving the video stream. For example, online video streaming services may encrypt the video stream before transmitting the video stream to a computing device of a consumer. The video stream is then decrypted when it is downloaded to the computing device. At block 304, the video stream is decoded on the computing device. Decoding the video stream enables a GPU of the computing device to perform operations on the incoming video stream.

At block 306, the video stream is post-processed. Video post processing at block 306 may include obtaining raw video data from the decoded video stream. At block 308, WiDi composition may be performed. WiDi composition includes composing the incoming video stream with the static portion of the desktop, as described above.

At block 310, the composed video data is pre-processed. Video pre-processing may include various techniques to optimize the composed video stream, such as improving the picture quality of the composed video stream or reducing the size of the video stream for a reduction in transmission bandwidth. At block 312, the video data is encoded. The pre-processed video data may be encoded to a predetermined format. At block 314, the video stream is encrypted.

At block 316, the video stream is sent to the remote adapter wirelessly. At block 318, the remote adapter may decrypt and decode the video stream. At block 320, the video stream may be sent to a remote device, such as a television. The video stream may be rendered on the remote device.

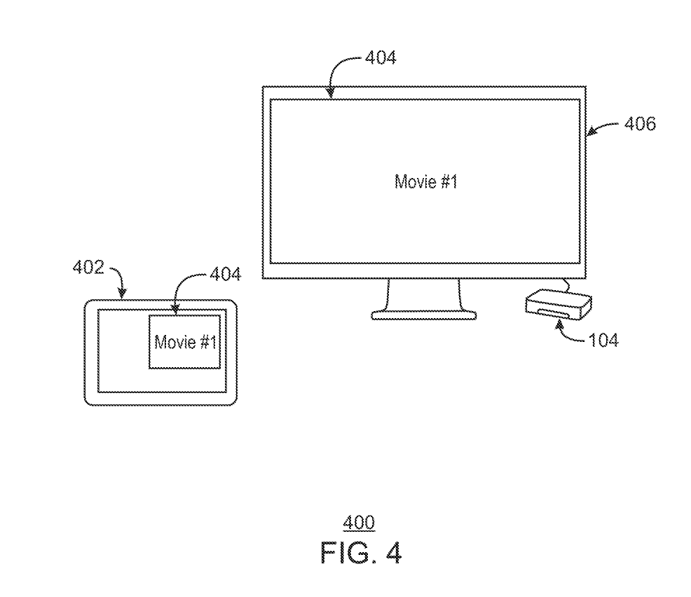

FIG. 4 is a diagram 400 describing WiDi in extended mode, in accordance with embodiments. The computing device shown is a tablet 402, with a desktop including a video portion 404. The tablet 402 sends the video portion 404 of the display to the remote adapter 104. In embodiments, the video portion 404 of the display may also be referred to as a video surface. As used herein, the video surface is a dynamic portion of the display that is used to render a video or other media on the desktop. The remote device shown is a monitor 406. The video portion 404 is rendered on the monitor 406 without the other fixed components of the desktop of the tablet 402.

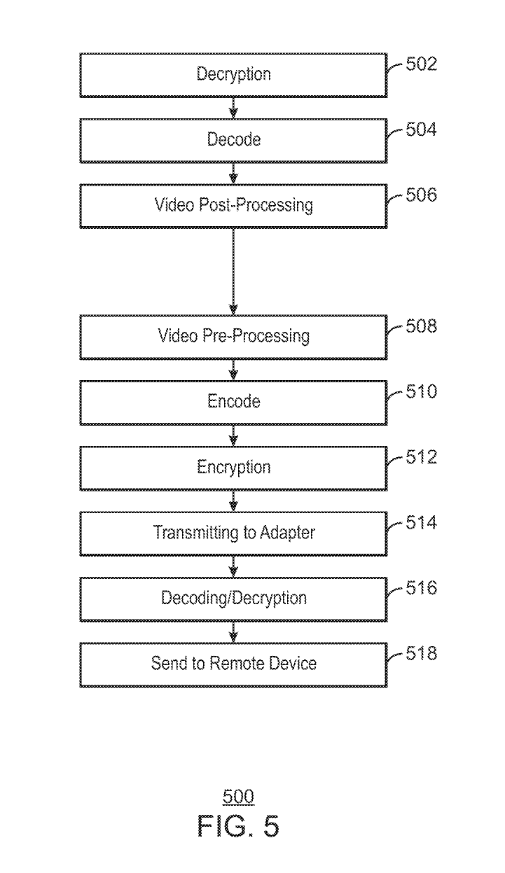

FIG. 5 is a process flow diagram 500 describing the processing pipeline for using WiDi in extended mode. The processing pipeline in extended mode is similar to the processing pipeline for performing WiDi in desktop mode. At block 502, an incoming video stream may be decrypted. At block 504, the video stream is decoded on the computing device. At block 506, the video stream is post-processed.

WiDi composition is not performed when using WiDi in extended mode. When in extended mode, the video surface is rendered on the remote device, without the static portion of the desktop. Thus, the static portion of the desktop is not composed with the video surface. At block 508, the video surface is pre-processed. At block 510, the video surface is encoded, and at block 512, the video surface is encrypted.

At block 514 the video surface may be transmitted to a remote adapter. At block 516, remote adapter may decrypt and decode the video surface. At block 518, the video surface may be sent to a remote device, such as a television. The video stream may be rendered on the remote device.

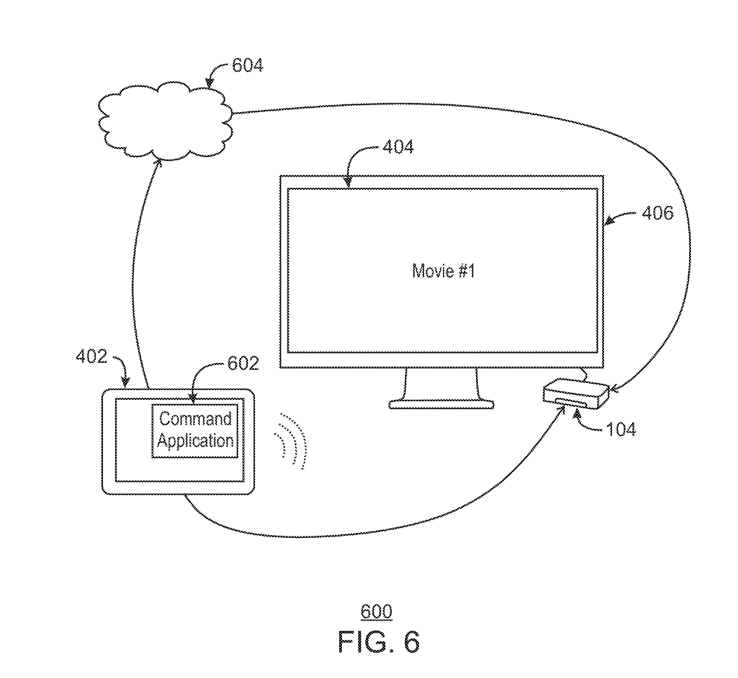

FIG. 6 is a diagram 600 describing WiDi in cloud mode, in accordance with embodiments. The computing device shown is a tablet 402, with a desktop including a command application 602. The tablet 402 may send a command to a cloud network 604 via the command application 602. The cloud network 604 may obtain the desired video stream. The cloud network 604 may send the desired video stream, such as the video 404, to the remote adapter 104. The remote adapter may then send the video stream to the monitor 406 in order to be rendered. Thus, the video stream is rendered on the monitor 406 without being downloaded to the tablet 402. The tablet 402 may communicate with the remote adapter 104 in order to control the video stream. For example, the command application 602 on the tablet 402 can be used to pause, fast forward, or rewind the video stream by communicating with the remote adapter.

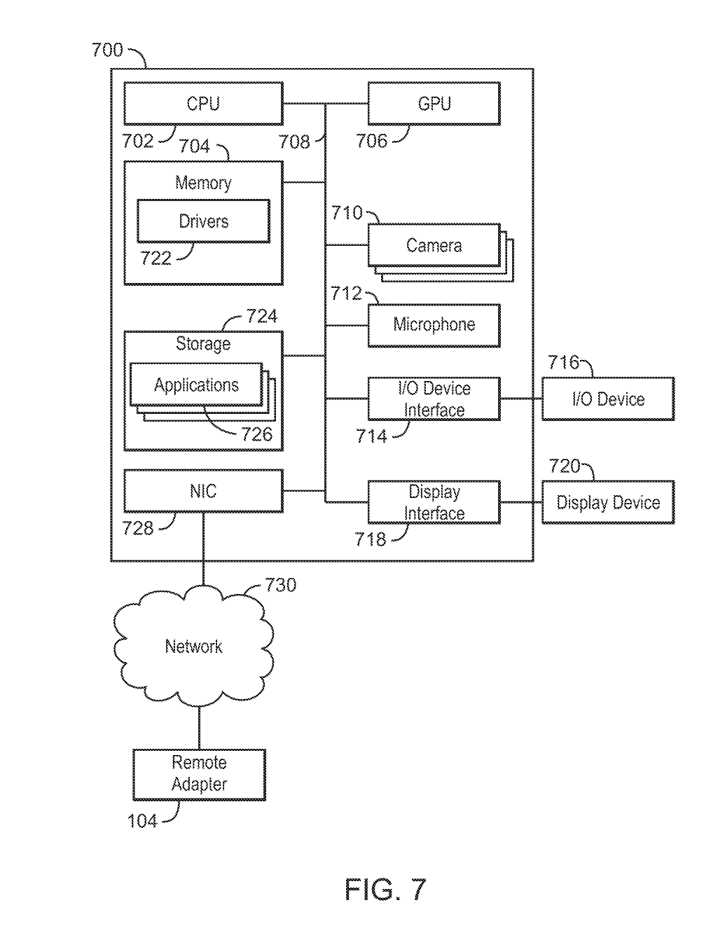

FIG. 7 is a block diagram of a computing device 700 that may be used to perform WiDi in cloud mode, in accordance with embodiments. The computing device 700 may be, for example, a laptop computer, desktop computer, tablet computer, mobile device, server, or cellular phone, among others. The computing device 700 may include a central processing unit (CPU) 702 that is configured to execute stored instructions, as well as a memory device 704 that stores instructions that are executable by the CPU 702. The CPU 702 can be a single core processor, a multi-core processor, a computing cluster, or any number of other configurations. Furthermore, the computing device 700 may include more than one CPU 702. The instructions that are executed by the CPU 702 may be used to perform WiDi in cloud mode. The memory device 704 can include random access memory (RAM), read only memory (ROM), flash memory, or any other suitable memory systems. For example, the memory device 704 may include dynamic random access memory (DRAM).

The computing device 700 may also include a graphics processing unit (GPU) 706. As shown, the CPU 702 may be connected through a bus 708 to the GPU 706. The GPU 706 may be configured to perform any number of graphics operations within the computing device 700. For example, the GPU 706 may be configured to render or manipulate graphics images, graphics frames, videos, or the like, to be displayed to a user of the computing device 700.

The computing device 700 may also include one or more cameras 710. The cameras 710 may be used to capture video and images for various uses, such as video conferencing and video chat applications. Additionally, the computing device 700 includes a microphone 712 that may be used to capture sound for various uses, such as a video conferencing and video chat applications. The CPU 702 may be connected through the bus 708 to other input/output (I/O) components using an I/O device interface 714 configured to connect the computing device 700 to one or more I/O devices 716. The I/O devices 716 may include, for example, a keyboard and a pointing device, wherein the pointing device may include a touchpad or a touchscreen, among others. The cameras 710, microphone 712, and I/O devices 716 may be built-in components of the computing device 700, or may be devices that are externally connected to the computing device 700.

The CPU 702 may also be linked through the bus 708 to a display interface 718 configured to connect the computing device 700 to a display device 720. The display device 720 may include a display screen that is a built-in component of the computing device 700. The display device 720 may also include a computer monitor, television, or projector, among others, that is externally connected to the computing device 700.

The memory device 704 may include one or more drivers 722. The drivers enable a piece of hardware or an application to communicate with the operating system, applications, or other hardware of the computing device 700.

The computing device 700 may also include a storage device 724. The storage device 724 is a physical memory such as a hard drive, an optical drive, a thumbdrive, an array of drives, or any combinations thereof. The storage device 724 may also include remote storage drives. The storage may also include one or more applications 726. The applications 726 include, but are not limited to, a command application 602.

A network interface controller (NIC) 728 may be configured to connect the computing device 700 through the bus 708 to a network 730. The network 730 may be a wide area network (WAN), local area network (LAN), or the Internet, among others. In embodiments, the computing device 700 may communicate with a remote adapter 104 using the network 730. The remote adapter 104 may be physically separated from the computing device from the computing device 700. In embodiments, the remote adapter 104 is another computing device.

The block diagram of FIG. 7 is not intended to indicate that the computing device 700 is to include all of the components shown in FIG. 7. Further, the computing device 700 may include any number of additional components not shown in FIG. 7, depending on the details of the specific implementation.

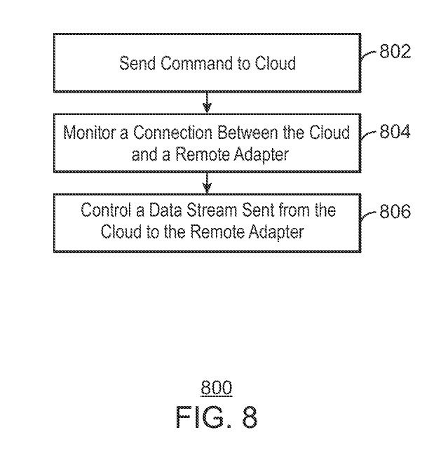

FIG. 8 is a process flow diagram showing a method 800 for WiDi cloud mode, in accordance with embodiments. In various embodiments, the method 800 may be executed on a computing device, such as the computing device 700.

At block 802, a command is sent to the cloud from the computing device. As discussed herein, the computing device may use a command application to send the command to the cloud network. The command includes information regarding the video stream or other data to be sent to the remote adapter. For example, the command includes the IP address of the video stream as well as the IP address of the WiDi adapter that will receive the video stream.

At block 804, a connection between the cloud and the remote adapter may be monitored. In embodiments, the computing device may ensure a connection is established The connection is established the cloud and the remote adapter based on the information contained in the command sent by the computing device. In embodiments, the connection may connect the remote adapter to access the desired data stream. The location of the desired data stream is determined using information contained in the command sent by the computing device. At block 806, the computing device can control the desired data stream sent from the cloud to the remote adapter via the connection. In embodiments, the computing device controls various aspects of the data stream playback by communicating with the remote adapter. Additionally, in embodiments, the computing device controls various aspects of the data stream playback by communicating with the cloud. When performing WiDi in cloud mode to render a video stream, the computing device does not decrypt, decode, post process, compose, pre process, encode, or encrypt the video stream. The video stream is sent to the remote adapter from the cloud network, bypassing the computing device. In this manner, there is no power consumption by the computing device when processing the video stream.

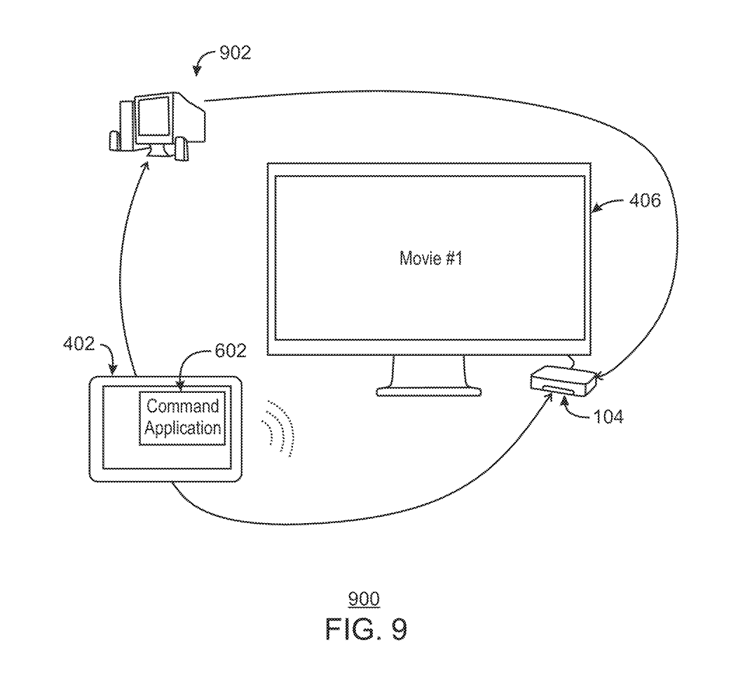

FIG. 9 is a diagram 900 describing WiDi in personal cloud mode, in accordance with embodiments. In embodiments, the cloud network may be a personal or home network. The computing device shown is a tablet 402, with a desktop including a command application 902. The tablet 402 may send a command to a personal or home network that includes a networked computer 902 via the command application 902. The desired video stream may be obtained from the networked computer 902. The networked computer 902 may send the desired video stream to the remote adapter 104. The remote adapter may then send the video stream to the monitor 406 in order to be rendered. For example, a user may have a tablet including the command application in the family room at home, which includes a television connected to a remote adapter. An additional computer may be located in another room of the home, with several video streams stored on the additional computer. Using WiDi in cloud mode, the tablet is able to send a command to the additional computer with instructions to send a video stream to the remote adapter. The additional computer may then send the video stream to the remote adapter, which then processes the video stream and sends it to the television to be rendered. The tablet 402 may communicate with the remote adapter 104 in order to control the video stream. For example, the command application 602 on the tablet 402 can be used to pause, fast forward, or rewind the video stream by communicating with the remote adapter.

In embodiments, WiDi cloud mode may operate as WiDi cloud audio mode. In WiDi cloud audio mode, the data stream is an audio stream that is played through speakers coupled with the remote adapter. Thus, a tablet may be used to send a command to the cloud network with the location of a desired audio stream. The audio stream may be sent from the cloud network to the remote adapter. The remote adapter may process the audio stream, and then send it to be played on a remote device. The remote device includes a television set or a stereo coupled with the remote adapter.

Additionally, in embodiments, WiDi cloud mode may operate as WiDi cloud photo mode. In WiDi cloud photo mode, the data stream includes photographs that are rendered on a remote device coupled with the remote adapter. Thus, a tablet may be used to send a command to the cloud network with the location of the desired photographs. The photographs may be sent from the cloud network to the remote adapter. The remote adapter may process the photographs, and then send them to be rendered on a remote device, such as television or computer monitor coupled with the remote adapter. For example, in personal cloud mode, the photographs may be located on an additional computer that is networked in the home network. The tablet is able to send a command to the additional computer with instructions to send the photographs to the remote adapter. The additional computer may then send the photographs to the remote adapter and the remote adapter may render the photographs on the television.

Further, in embodiments, WiDi cloud mode may operate as WiDi cloud game mode. In WiDi cloud game mode, the data stream is audio and video associated with a game on the computing device. The actual code for the game may be located on a cloud network or a personal cloud network. The audio and video associated with the game may be sent to the remote adapter in order to be rendered on a remote device. However, a user may control the video game using controls on the computing device.

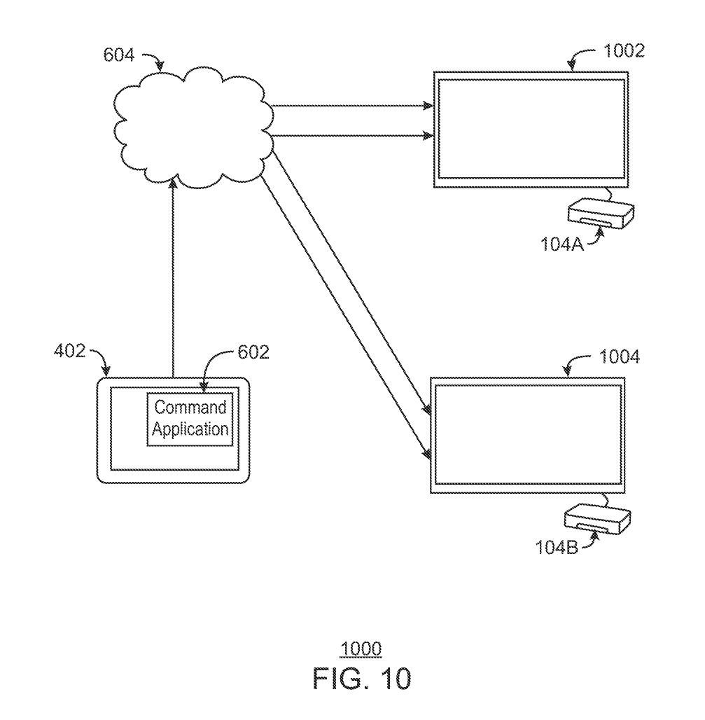

FIG. 10 is a diagram 1000 describing WiDi cloud mode with a cloud controller, in accordance with embodiments. In embodiments, the computing device may be used as a cloud controller, where the same data stream is sent from the cloud to several remote adapters at various locations at the command of the computing device. For example, tablet 402 may send a command to the cloud network 604 using the command application 602. The tablet may send commands for WiDi cloud audio mode, WiDi cloud photo mode, WiDi cloud video mode, or WiDi cloud game mode. The command may also include the location of several remote adapters, such as remote adapter 104A and remote adapter 104B. Further, the remote adapters may be separated by any distance. The remote adapter 104A may render the data stream using remote device 1002, while the remote adapter 1048 may render the data stream using remote device 1004. The cloud may send audio, photo, video, or gaming data streams to remote adapter 104A and remote adapter 1048 based on the information contained in the command sent by tablet 402. In this manner, audio, photo, video, and gaming data streams may be shared between multiple people around the world at the same time.

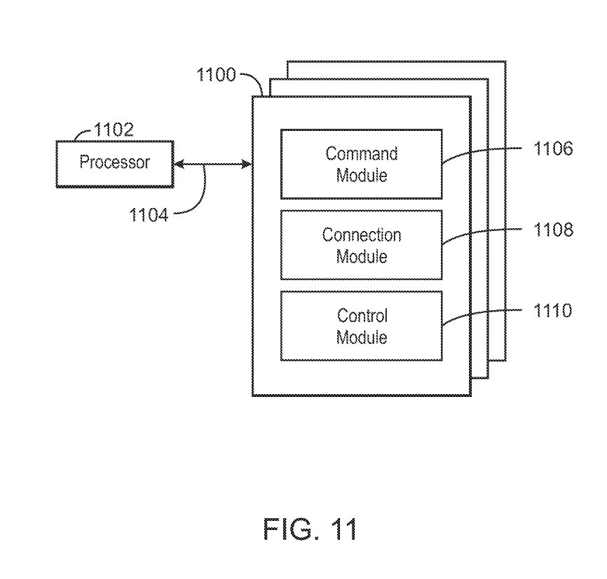

FIG. 11 is a block diagram showing tangible, non-transitory computer-readable media 1100 that stores code for WiDi cloud mode, in accordance with embodiments. The tangible, non-transitory computer-readable media 1100 may be accessed by a processor 1102 over a computer bus 1104. Furthermore, the tangible, non-transitory computer-readable media 1100 may include code configured to direct the processor 1102 to perform the methods described herein.

The various software components discussed herein may be stored on the tangible, non-transitory computer-readable media 1100, as indicated in FIG. 11. For example, a command module 1106 may be configured to send a command from a computing device to a cloud network. A connection module 1108 may be configured to monitor a connection between the cloud network and a remote adapter based on the command. Further, a control module 1110 may be configured to control a data stream sent from the cloud network to the remote adapter via the connection.

The block diagram of FIG. 11 is not intended to indicate that the tangible, non-transitory computer-readable media 1100 is to include all of the components shown in FIG. 11. Further, the tangible, non-transitory computer-readable media 1100 may include any number of additional components not shown in FIG. 11, depending on the details of the specific implementation.

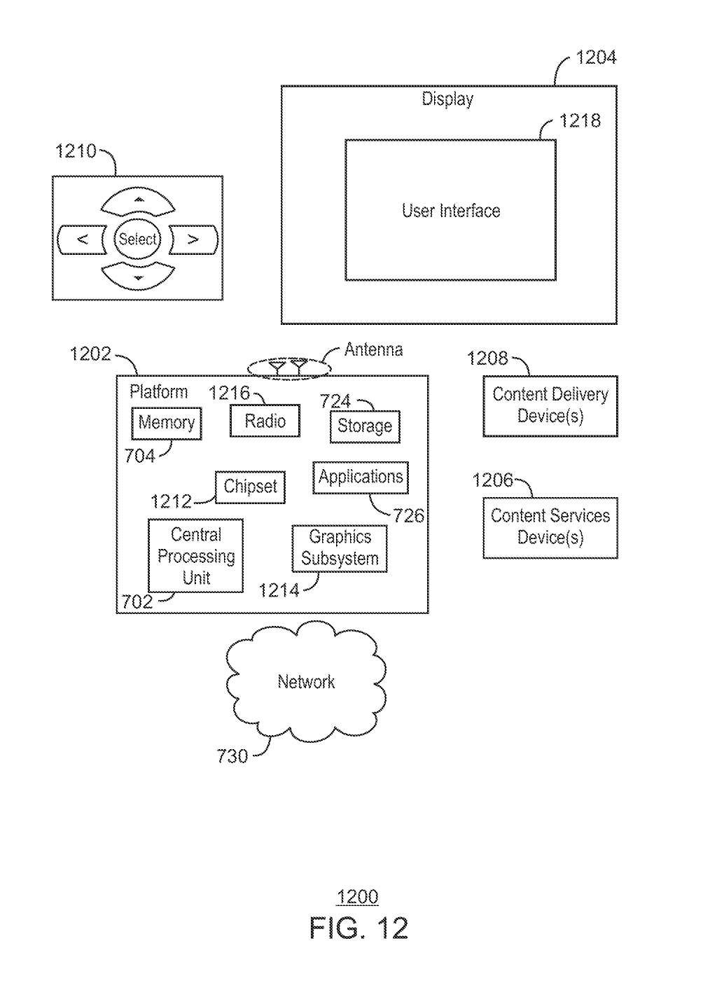

FIG. 12 is a block diagram of an exemplary system 1200 for implementing WiDi cloud mode. Like numbered items are as described with respect to FIG. 1. In some embodiments, the system 1200 is a media system. In addition, the system 1200 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, or the like.

In various embodiments, the system 1200 comprises a platform 1202 coupled to a display 1204. The platform 1202 may receive content from a content device, such as content services device(s) 1206 or content delivery device(s) 1208, or other similar content sources. A navigation controller 1210 including one or more navigation features may be used to interact with, for example, the platform 1202 and/or the display 1204. Each of these components is described in more detail below.

The platform 1202 may include any combination of a chipset 1212, a central processing unit (CPU) 102, a memory device 704, a storage device 724, a graphics subsystem 1214, applications 726, and a radio 1216. The chipset 1212 may provide intercommunication among the CPU 102, the memory device 704, the storage device 724, the graphics subsystem 1214, the applications 726, and the radio 1214. For example, the chipset 1212 may include a storage adapter (not shown) capable of providing intercommunication with the storage device 724.

The processor 702 may be implemented as Complex Instruction Set Computer (CISC) or Reduced Instruction Set Computer (RISC) processors, x86 instruction set compatible processors, multi-core, or any other microprocessor or central processing unit (CPU). In some embodiments, the processor 702 includes dual-core processor(s), dual-core mobile processor(s), or the like.

The memory device 704 may be implemented as a volatile memory device such as, but not limited to, a Random Access Memory (RAM), Dynamic Random Access Memory (DRAM), or Static RAM (SRAM). The storage device 724 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In some embodiments, the storage device 724 includes technology to increase the storage performance enhanced protection for valuable digital media when multiple hard drives are included, for example.

The graphics subsystem 1214 may perform processing of images such as still or video for display. The graphics subsystem 1214 may include a graphics processing unit (GPU), such as the GPU 706, or a visual processing unit (VPU), for example. An analog or digital interface may be used to communicatively couple the graphics subsystem 1214 and the display 1204. For example, the interface may be any of a High-Definition Multimedia Interface, DisplayPort, wireless HDMI, and/or wireless HD compliant techniques. The graphics subsystem 1214 may be integrated into the processor or the chipset 1212. Alternatively, the graphics subsystem 1214 may be a stand-alone card communicatively coupled to the chipset 1212.

The graphics and/or video processing techniques described herein may be implemented in various hardware architectures. For example, graphics and/or video functionality may be integrated within the chipset 1212. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

The radio 1216 may include one or more radios capable of transmitting and receiving signals using various suitable wireless communications techniques. Such techniques may involve communications across one or more wireless networks. Exemplary wireless networks include wireless local area networks (WLANs), wireless personal area networks (WPANs), wireless metropolitan area network (WMANs), cellular networks, satellite networks, or the like. In communicating across such networks, the radio 1216 may operate in accordance with one or more applicable standards in any version.

The display 1204 may include any television type monitor or display. For example, the display 1204 may include a computer display screen, touch screen display, video monitor, television, or the like. The display 1204 may be digital and/or analog. In some embodiments, the display 1204 is a holographic display. Also, the display 1204 may be a transparent surface that may receive a visual projection. Such projections may convey various forms of information, images, objects, or the like. For example, such projections may be a visual overlay for a mobile augmented reality (MAR) application. Under the control of one or more applications 726, the platform 1202 may display a user interface 1218 on the display 1204.

The content services device(s) 1206 may be hosted by any national, international, or independent service and, thus, may be accessible to the platform 1202 via the Internet, for example. The content services device(s) 1206 may be coupled to the platform 1202 and/or to the display 1204. The platform 1202 and/or the content services device(s) 1206 may be coupled to a network 730 to communicate (e.g., send and/or receive) media information to and from the network 730. The content delivery device(s) 1208 also may be coupled to the platform 1202 and/or to the display 1204.

The content services device(s) 1206 may include a cable television box, personal computer, network, telephone, or Internet-enabled device capable of delivering digital information. In addition, the content services device(s) 1206 may include any other similar devices capable of unidirectionally or bidirectionally communicating content between content providers and the platform 1202 or the display 1204, via the network 730 or directly. It will be appreciated that the content may be communicated unidirectionally and/or bidirectionally to and from any one of the components in the system 1200 and a content provider via the network 730. Examples of content may include any media information including, for example, video, music, medical and gaming information, and so forth.

The content services device(s) 1206 may receive content such as cable television programming including media information, digital information, or other content. Examples of content providers may include any cable or satellite television or radio or Internet content providers, among others.

In some embodiments, the platform 1202 receives control signals from the navigation controller 1210, which includes one or more navigation features. The navigation features of the navigation controller 1210 may be used to interact with the user interface 1218, for example. The navigation controller 1210 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures. Physical gestures include but are not limited to facial expressions, facial movements, movement of various limbs, body movements, body language or any combination thereof. Such physical gestures can be recognized and translated into commands or instructions.

Movements of the navigation features of the navigation controller 1210 may be echoed on the display 1204 by movements of a pointer, cursor, focus ring, or other visual indicators displayed on the display 1204. For example, under the control of the applications 726, the navigation features located on the navigation controller 1210 may be mapped to virtual navigation features displayed on the user interface 1218. In some embodiments, the navigation controller 1210 may not be a separate component but, rather, may be integrated into the platform 1202 and/or the display 1204.

The system 1200 may include drivers (not shown) that include technology to enable users to instantly turn on and off the platform 1202 with the touch of a button after initial boot-up, when enabled, for example. Program logic may allow the platform 1202 to stream content to media adaptors or other content services device(s) 1206 or content delivery device(s) 1208 when the platform is turned “off.” In addition, the chipset 1212 may include hardware and/or software support for 5.1 surround sound audio and/or high definition 7.1 surround sound audio, for example. The drivers may include a graphics driver for integrated graphics platforms. In some embodiments, the graphics driver includes a peripheral component interconnect express (PCIe) graphics card.

In various embodiments, any one or more of the components shown in the system 1200 may be integrated. For example, the platform 1202 and the content services device(s) 1206 may be integrated; the platform 1202 and the content delivery device(s) 1208 may be integrated; or the platform 1202, the content services device(s) 1206, and the content delivery device(s) 1208 may be integrated. In some embodiments, the platform 1202 and the display 1204 are an integrated unit. The display 1204 and the content service device(s) 1206 may be integrated, or the display 1204 and the content delivery device(s) 1208 may be integrated, for example.

The system 1200 may be implemented as a wireless system or a wired system. When implemented as a wireless system, the system 1200 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum. When implemented as a wired system, the system 1200 may include components and interfaces suitable for communicating over wired communications media, such as input/output (I/O) adapters, physical connectors to connect the I/O adapter with a corresponding wired communications medium, a network interface card (NIC), disc controller, video controller, audio controller, or the like. Examples of wired communications media may include a wire, cable, metal leads, printed circuit board (PCB), backplane, switch fabric, semiconductor material, twisted-pair wire, co-axial cable, fiber optics, or the like.

The platform 1202 may establish one or more logical or physical channels to communicate information. The information may include media information and control information. Media information may refer to any data representing content meant for a user. Examples of content may include, for example, data from a voice conversation, videoconference, streaming video, electronic mail (email) message, voice mail message, alphanumeric symbols, graphics, image, video, text, and the like. Data from a voice conversation may be, for example, speech information, silence periods, background noise, comfort noise, tones, and the like. Control information may refer to any data representing commands, instructions or control words meant for an automated system. For example, control information may be used to route media information through a system, or instruct a node to process the media information in a predetermined manner. The embodiments, however, are not limited to the elements or the context shown or described in FIG. 12.

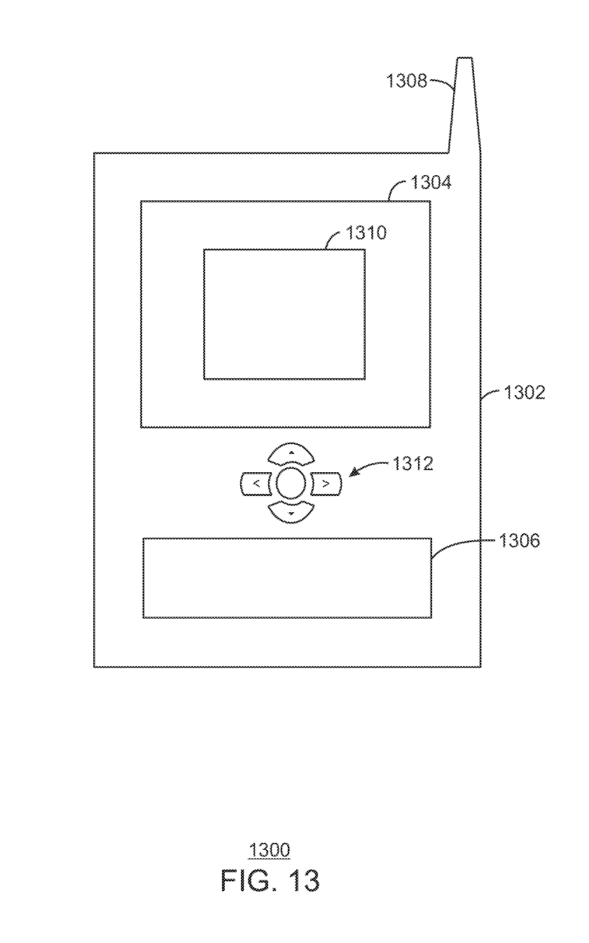

FIG. 13 is a schematic of a small form factor device 1300 in which the system 1200 of FIG. 12 may be embodied. Like numbered items are as described with respect to FIG. 12. In some embodiments, for example, the device 1300 is implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and the like.

An example of a mobile computing device may also include a computer that is arranged to be worn by a person, such as a wrist computer, finger computer, ring computer, eyeglass computer, belt-clip computer, arm-band computer, shoe computer, clothing computer, or any other suitable type of wearable computer. For example, the mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well.

As shown in FIG. 13, the device 1300 may include a housing 1302, a display 1304, an input/output (I/O) device 1306, and an antenna 1308. The device 1300 may also include navigation features 1310. The display 1304 may include any suitable display unit for displaying information appropriate for a mobile computing device. The I/O device 1306 may include any suitable I/O device for entering information into a mobile computing device. For example, the I/O device 1306 may include an alphanumeric keyboard, a numeric keypad, a touch pad, input keys, buttons, switches, rocker switches, microphones, speakers, a voice recognition device and software, or the like. Information may also be entered into the device 1300 by way of microphone. Such information may be digitized by a voice recognition device.

### Example 1

A method for WiDi cloud mode is described herein. The method includes sending a command from a computing device to a cloud network. A connection may be monitored between the cloud network and a remote adapter based on the command. A data stream sent via the connection from the cloud network to the remote adapter may be controlled.

The data stream may be a video stream, and the video stream may be decoded and decrypted at the remote adapter. Further, the data stream may be a video stream that is rendered on a remote device. The cloud may be a personal or home network, and the video stream may be obtained from a networked computer. The data stream may also be an audio stream that is played through speakers coupled with the remote adapter. Additionally, the data stream may include photographs. Moreover, the data stream may be audio and video associated with a computer game played on the computing device. The computing device may also be configured to operate as a cloud controller.

### Example 2

A computing device is described herein. The computing device includes a central processing unit (CPU) that is configured to execute stored instructions and a storage device that stores instructions. The storage device includes processor executable code that, when executed by the CPU, is configured to send a command from a computing device to a cloud network. A connection may be monitored between the cloud network and a remote adapter based on the command. A data stream sent via a connection from the cloud network to the remote adapter may be controlled.

The data stream may be a video stream, and the video stream may be decoded and decrypted at the remote adapter. Further, the data stream may be a video stream that is rendered on a remote device. The cloud may be a personal or home network, and the video stream may be obtained from a networked computer. The data stream may also be an audio stream that is played through speakers coupled with the remote adapter. Moreover, the data stream may be audio and video associated with a computer game played on the computing device. The computing device may be configured to operate as a cloud controller. The computing device may also include a radio and a display, the radio and display communicatively coupled at least to the central processing unit.

### Example 3

At least one non-transitory machine readable medium having instructions stored therein is described herein. In response to being executed on a computing device, the instructions cause the computing device to send a command from a computing device to a cloud network. A connection may be monitored the cloud network and a remote adapter based on the command. A data stream sent via the connection from the cloud network to the remote adapter may be controlled. The data stream may be a video stream, and the video stream may be decoded and decrypted at the remote adapter. Further, the data stream may be a video stream that is rendered on a remote device. The cloud may be a personal or home network, and the video stream may be obtained from a networked computer.

It is to be understood that specifics in the aforementioned examples may be used anywhere in one or more embodiments. For instance, all optional features of the computing device described above may also be implemented with respect to either of the methods or the computer-readable medium described herein. Furthermore, although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. A method for WiDi cloud mode, comprising:
sending a command from a computing device to a cloud network;
monitoring a connection between the cloud network and a remote adapter based on the command; and
controlling a data stream sent from the cloud network to the remote adapter via the connection.

2. The method of claim 1, wherein the data stream is a video stream, and the video stream is decoded and decrypted at the remote adapter.

3. The method of claim 1, wherein the data stream is a video stream that is rendered on a remote device.

4. The method of claim 1, wherein the cloud network is a personal or home network, further comprising obtaining the video stream from a networked computer.

5. The method of claim 1, wherein the data stream is an audio stream that is played through speakers coupled with the remote adapter.

6. The method of claim 1, wherein the data stream includes photographs.

7. The method of claim 1, wherein the data stream is audio and video associated with a computer game played on the computing device.

8. The method of claim 1, wherein the computing device is configured to operate as a cloud controller.

9. A computing device, comprising:
a central processing unit (CPU) that is configured to execute stored instructions and a storage device that stores instructions, wherein the storage device includes processor executable code that, when executed by the CPU, is configured to:
send a command from a computing device to a cloud network;
monitor a connection between the cloud network and a remote adapter based on the command; and
control a data stream sent from the cloud network to the remote adapter via the connection.

10. The computing device of claim 9, wherein the data stream is a video stream, and the video stream is decoded and decrypted at the remote adapter.

11. The computing device of claim 9, wherein the data stream is a video stream that is rendered on a remote device.

12. The computing device of claim 9, wherein the cloud is a personal or home network, further comprising obtaining the video stream from a networked computer.

13. The computing device of claim 9, wherein the data stream is an audio stream that plays through a speaker coupled with the remote adapter.

14. The computing device of claim 9, wherein the data stream is audio and video associated with a computer game that is played on the computing device.

15. The computing device of claim 9, wherein the computing device is configured to operate as a cloud controller.

16. The computing device of claim 9, further comprising a radio and a display, the radio and display communicatively coupled at least to the central processing unit.

17. At least one machine readable medium having instructions stored therein that, in response to being executed on a computing device, cause the computing device to:
send a command from a computing device to a cloud network;
monitor a connection between the cloud network and a remote adapter based on the command; and
control a data stream sent from the cloud network to the remote adapter via the connection.

18. The at least one machine readable medium of claim 17 wherein the data stream is a video stream, and the video stream is decoded and decrypted at the remote adapter.

19. The at least one machine readable medium of claim 17, wherein the data stream is a video stream that is rendered on a remote device.

20. The at least one machine readable medium of claim 17, wherein the cloud is a personal or home network, further comprising obtaining the video stream from a networked computer.
